(19) United States
(12) Patent Application Publication
(10) Pub. No.: US 2015/0012367 A1
(43) Pub. Date: Jan. 8, 2015

(54) FIXED-PRICING FOR GUARANTEED DELIVERY OF ONLINE ADVERTISEMENTS

(71) Applicant: Facebook, Inc., Menlo Park, CA (US)

(72) Inventors: Fidji Nahema Simo, Palo Alto, CA (US); Sourav Chatterji, Fremont, CA (US)

(21) Appl. No.: 13/933,595

(22) Filed: Jul. 2, 2013

(51) Int. Cl. G06Q 30/02

(52) U.S. Cl. CPC G06Q 30/0275
USPC 705/14.71

(57) ABSTRACT

An online system sells fixed-price advertising guaranteeing a number of impressions or a number of actions associated with an advertisement by users of the online system. The price for an advertisement associated with a guaranteed number of impressions or actions is based on a target bid amount for selecting the advertisement from a group of advertisements using a conventional pricing scheme and a predicted likelihood that the guaranteed number of impressions or actions occur. The price may be further adjusted by a premium that accounts for a risk of revenue lost by the online system for displaying an advertisement associated with a guaranteed number of impressions or a number of actions rather than conventionally-priced advertisements.

### BACKGROUND

This invention relates generally to online systems, and in particular to pricing advertisements presented by an online system.

Presenting advertisements to users of an online system allows an advertiser to gain public attention for products or services and to persuade online system users to take an action regarding the advertiser's products, services, opinions, or causes. Conventional online systems select and present an advertisement to a user satisfying one or more targeting criteria associated with the advertisement; the online system then charges an advertiser associated with the presented advertisement based on a bid amount associated with the advertisement and provided by the advertiser. For example, an advertisement having a highest bid amount from a group of advertisements eligible for presentation to a user satisfying one or more targeting criteria associated with the advertisement is selected, and the advertiser associated with the selected advertisement is charged an amount based on the bid amounts of other advertisements eligible for presentation to the user.

However, selecting advertisements based on their associated bid amounts makes it uncertain that any particular advertisement will be selected for presentation to users of the online system. Accordingly, advertisers may be willing to pay an online system a premium for a guaranteed number of impressions of an advertisement or for a guaranteed number of actions taken by users when their advertisements are presented. For example, advertisers may be willing to pay an online system premium amount exceeding a conventional bid amount for an advertisement to guarantee that installation of an application associated with an advertisement by a specified number of online system users.

### SUMMARY

To maximize revenue and provide advertisers with a measure of certainty regarding actions associated with an advertisement by users, an online system allows advertisements to bypass a conventional selection mechanism. The online system allows advertisers to pay a flat fee to the online system for a guaranteed number of actions associated with one or more advertisements. For example, an advertiser pays the online system a fixed amount for a guaranteed number of presentations of an advertisement to online system users or for a guaranteed number of actions performed by users presented with an advertisement.

The price for a guaranteed number of actions associated with an advertisement (e.g., impressions or actions performed by users presented with the advertisement) is based on a target bid for the advertisement to be selected from a group of advertisements and a predicted likelihood that at least a threshold number of actions satisfying the guarantee occur. For example, the target bid amount indicates an amount of compensation received by the online system to select the advertisement from other advertisements via an auction process or other suitable selection process. The likelihood that at least a threshold number of actions satisfying the guarantee occur may be based on prior actions performed by users on advertisements with similar content, targeting criteria, and display times to an advertisement. In some embodiments, the price is further adjusted by a premium accounting for the risk of lost revenue to the online system as a result of guaranteeing a number of actions associated with the advertisement. The premium may be based on a margin of error in the predicted bid amount and the predicted likelihood that a sufficient number of actions to satisfy the terms of the guarantee will occur, and may also be based on the bid amounts for ads with similar content, targeting criteria, and display times.

An advertiser associated with an ad may be charged the price in advance of presentation of the advertisement when the online system guarantees a number of actions associated with the advertisement. If the advertiser is charged in advance of ad presentation, the ad is presented until the guaranteed number of impressions or actions is achieved. Alternatively, the advertiser is not charged until the number of actions specified by the guarantee is achieved.

### BRIEF DESCRIPTION OF THE DRAWINGS

FIG. 1 is a block diagram of a system environment in which an online system operates, in accordance with an embodiment of the invention.

FIG. 2 is a block diagram of an online system, in accordance with an embodiment of the invention.

FIG. 3 is a flow chart of a method for pricing an advertisement based on a guaranteed number of actions associated with the advertisement, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

An online system derives revenue by displaying advertisements to its users. The online system may act as a publishing system by receiving advertisements from advertisers and providing the advertisements to users, or the online system may act as an advertisement network by receiving advertisements from advertisers and providing them to other publishing sites. Alternatively, the online system may perform advertisement pricing for third parties.

To maximize revenue and provide advertisers with a measure of certainty regarding actions associated with an advertisement by users, the online system guarantees delivery of an advertisement to a predefined block of users over a period of time (“guaranteed impressions”) or a number of actions associated with presentation of an advertisement (“guaranteed actions”) for a fixed price. Examples of predefined blocks of users include users logged-in to the online system, male users, and users between the ages of 18 and 25. Examples of guaranteed actions include users accessing an advertisement, users playing a video associated with an advertisement, users sharing the advertisement with others, etc. To achieve a guaranteed action for an advertisement, the online system presents an advertisement to users matching one or more of the advertisement's targeting criteria or predicts the likelihood of users performing a specified action and presents the advertisement to users having at least a threshold likelihood of performing the action. A guaranteed number of impressions or actions may be associated with a specific type of platform (e.g., operating system) or specific type of device (e.g., smart phone, laptop computer, etc.).

To determine a price for guaranteeing a number of impressions or actions associated with an advertisement (“guaranteed advertisement”), the online system calculates a target price for the guaranteed advertisement. The target price is based on a projected bid amount, which specifies an amount of compensation to be received by the online system to select the guaranteed advertisement from other advertisements via an auction process or other suitable selection process, and based on a likelihood that a threshold number of actions or impressions occur if the advertisement is displayed. The guaranteed advertisement's price may be adjusted by a premium that accounts for a risk of revenue lost by the online system by presenting the guaranteed advertisement in place of non-guaranteed advertisements. For example, a premium adjusts the target price if an advertiser is not charged until the guaranteed number of actions occur, allowing the online system to mitigate the risk of revenue lost from lost opportunities to present advertisements for which the online system receives compensation based on impressions if greater than a predicted number of impressions of a guaranteed advertisement are used to reach the guaranteed number of actions associated with the guaranteed advertisement.

Various methods may be used to charge advertisers for presentation of guaranteed advertisements. In one embodiment, an advertiser associated with a guaranteed advertisement is charged in advance of presentation of the guaranteed advertisement. For example, the advertiser is charged before presentation of an advertisement when the online system guarantees a number of impressions or actions associated with the advertisement. If the advertiser is charged before presentation of an advertisement, the advertisement is presented to online system users until the guaranteed number of impressions or actions is achieved. Alternatively, the advertiser is charged after achievement of the number of impressions or actions specified in the guarantee. Other models may be used by the online system to charge advertisers for presentation of guaranteed advertisements. For example, the advertiser is charged an up-front amount before the delivery of a guaranteed advertisement and charged a pro-rated amount at designated intervals corresponding to the number of impressions or actions achieved during each designated interval.

### System Architecture

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

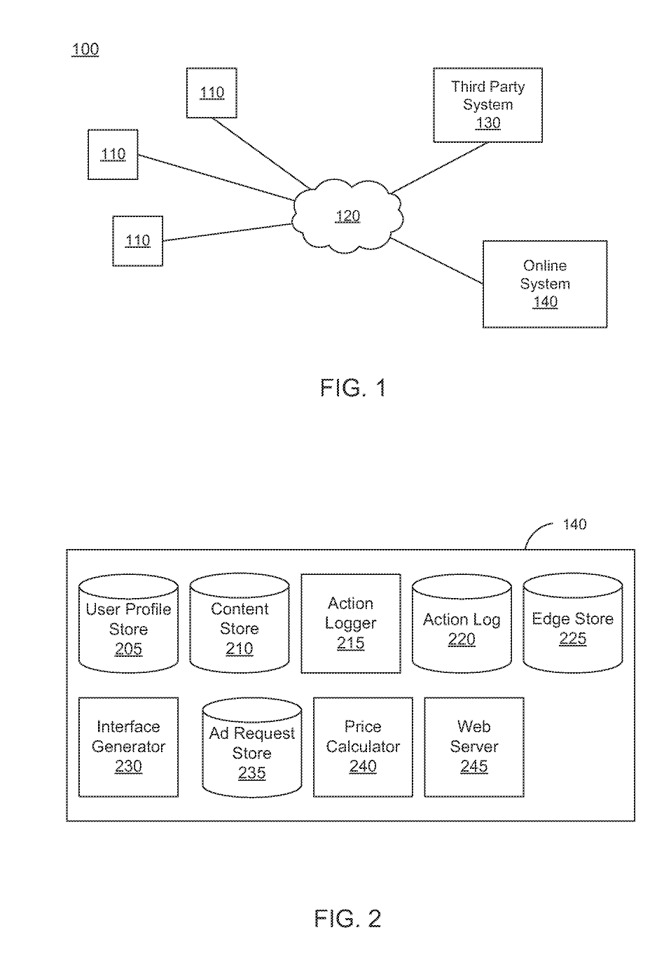

One or more third party systems 130 may be coupled to the network 120 for communicating with the online system 140, which is further described below in conjunction with FIG. 2. For example, the online system 140 is a social networking system. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130.

FIG. 2 is an example block diagram of an architecture of the online system 140. The online system 140 shown in FIG. 2 includes a user profile store 205, a content store 210, an action logger 215, an action log 220, an edge store 225, an interface generator 230, an ad request store 235, a price calculator 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, social networking system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The interface generator 230 generates one or more interfaces, such as web pages, including content from the online system 140. For example, interfaces generated by the interface generator 230 include images, video, profile information, or other data. The interface generator 230 also generates one or more interfaces allowing the online system 140 to request information from users and for users to provide information to the online system 140 via the client device 110 and the network 120. For example, the interface generator 230 generates a form for a user to provide biographic information, such as the user's age, for inclusion in the user's user profile. When other users request a user's profile page, the interface generator 230 retrieves data from the profile store 205 and generates a representation of the information in the user profile for presentation by the client device 110.

One or more advertisement requests (“ad requests”) are stored in the ad request store 235. An advertisement request includes advertisement content and a bid amount. The advertisement content is text data, image data, audio data, video data, or any other data suitable for presentation to a user. In various embodiments, the advertisement content also includes a network address specifying a landing page to which a user is directed when the advertisement is accessed.

The bid amount is associated with an advertisement by an advertiser and specifies an amount of compensation the advertiser provides the online system 140 if the advertisement is presented to a user or accessed by a user. In one embodiment, the bid amount is used by the online system to determine an expected value, such as monetary compensation, received by the online system 140 for presenting the advertisement to a user, if the advertisement receives a user interaction, or based on any other suitable condition. For example, the bid amount specifies a monetary amount that the online system 140 receives from the advertiser if the advertisement is displayed and the expected value is determined based on the bid amount and a probability of a user accessing the displayed advertisement.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. The targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The price calculator 240 determines associated with a guaranteed number of impressions or actions associated with an advertisement (a “guaranteed advertisement”). To determine a guaranteed advertisement's price, the price calculator 240 uses a target bid amount for selecting an advertisement from a plurality of advertisements and a likelihood of a number of actions satisfying the guaranteed number of actions or impressions occurring. In one embodiment, the price is adjusted by a premium accounting for the risk of revenue lost by the online system 140 by presenting the guaranteed advertisement rather than advertisements for which compensation is received based on advertisement impression. The target bid amount indicates an amount received by the online system 140 to select an advertisement for display from a group of advertisements. In one embodiment, the target bid amount is determined based on bid amounts of advertisements with similar content, targeting criteria, and display times previously selected via an auction or other selection process.

Machine-learning algorithms may be used to determine the target bid amount from data associated with previous advertisement selection. For example, the price calculator 240 determines a target bid amount associated with an advertisement for an application that plays music and is targeted toward teenagers for display during after-school hours based on prior auctions, or other advertisement selections, in the past month in which advertisements for similar applications having similar targeting criteria were selected. Further, machine-learning algorithms may determine that a recent increase in advertising for similar applications warrants increasing the bid amount for the advertisement from the bid amounts for prior advertisement selection.

To determine the likelihood of at least the guaranteed number of actions or impressions occurring, the price calculator 240 retrieves, from the action log 220, previous actions performed by users when presented with advertisements having similar content, targeting criteria, and display times to a guaranteed advertisement. For example, the price calculator 240 determines a 90% likelihood of 1,000 users purchasing at least $100 in merchandise from an online store if an advertisement is presented. The price calculator 240 may determine this likelihood based on prior purchases by online system users through online stores selling similar merchandise after viewing advertisements for the online stores. In various embodiments, machine-learning algorithms are used to predict the likelihood of a number of actions or impressions associated with an advertisement based on changes in user interactions over time or during certain times of year.

The premium that may be used to adjust the price for a guaranteed advertisement accounts for the risk of lost revenue to the online system 140 for guaranteeing a number of impressions or actions associated with a guaranteed advertisement. In one embodiment, the premium is based on a margin of error in the predicted bid amount, as well as a margin of error in the predicted likelihood of the guaranteed number of actions or impressions associated with the advertisement occurring within designated parameters (e.g., one week). The premium may also be based on bid amounts associated with advertisements having similar content, targeting criteria, and display times to a guaranteed advertisement.

The web server 245 links the online system 140 via the network 120 to the one or more client devices 110, as well as to the one or more third party systems 130. The web server 245 serves web pages, as well as other web-related content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that is stored in the content store 210. Additionally, the web server 245 may provide application programming interface (API) functionality to send data directly to native client device operating systems, such as IOS®, ANDROID™, WEBOS® or RIM®.

### Pricing Guaranteed Advertisements

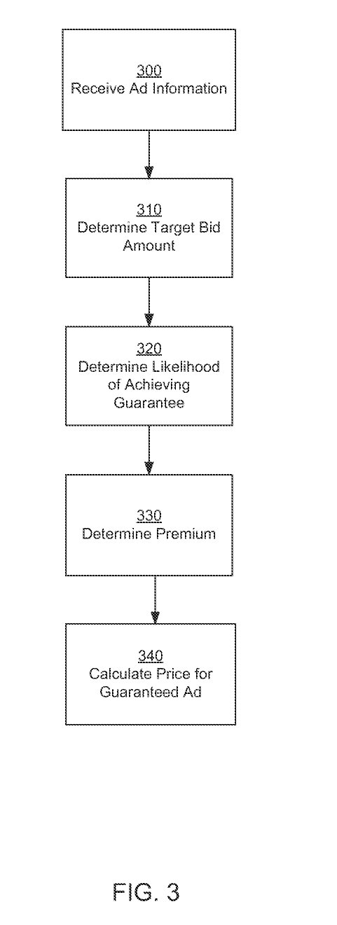

FIG. 3 is a flow chart of a method for pricing an advertisement based on a guaranteed number of actions associated with the advertisement. The online system 140 receives 300 information about an advertisement and a guarantee of one or more actions associated with presenting the advertisement to one or more users of the online system 140. For example, the online system receives 300 content for an advertisement, a bid amount for presentation of the advertisement, and one or more targeting criteria associated with the advertisement. Information describing the guarantee of one or more actions associated with presenting the advertisement identifies a type of action and a number of the actions. For example the information describing the guarantee of one or more actions identifies a number of impressions of the advertisement, identifies an action and a number associated with the action, a time interval associated with the action, and one or more characteristics of users associated with the one or more actions.

Based on the information about the advertisement and the guarantee of one or more actions, the online system 140 determines 310 a target bid amount for the received advertisement. The target bid amount indicates an amount of compensation to the online system 140 for selecting the advertisement from one or more advertisements for presentation to online system users. Bid amounts or amounts of compensation received associated with additional advertisements having similar subject matter, targeting criteria, or display times are retrieved and used to determine 310 the target bid amount. For example, if the received information about the advertisement specifies 10,000 guaranteed impressions for an advertisement displayed on Black Friday, the price calculator 240 of the online system 140 retrieves amounts received by the online system 140 for presentation of additional advertisements with similar subject matter on Black Friday in previous years and determines 310 the target bid amount for the advertisement based on the retrieved information. Examples of retrieved information for determining 310 the advertisement's target bid amount include bid amounts received for previously.

Using the received information describing the advertisement and the guaranteed actions associated with presentation of the advertisement, the online system 140 determines 320 the likelihood of the number of actions identified by the received information occurring if the advertisement is presented to online system users. To determine 320 the likelihood of the number of guaranteed actions occurring, the online system 140 retrieves previous actions performed by users when presented with advertisements having similar content, targeting criteria, and display times to a guaranteed advertisement. For example, if received information identifies purchase of 100 impressions of an advertisement, the online system 140 determines the likelihood of 100 impressions of the advertisement based on targeting criteria in the received information to identify users eligible to be presented with the advertisement; if the targeting criteria are broad (e.g., the target block of users is all logged-in users), the likelihood of 100 impressions occurring is 100% as the online system 140 may display the advertisement to the first 100 users in a display period identified as satisfying the targeting criteria. However, if the received information requests a number of specific actions based on presentation of an advertisement with specific targeting criteria within a relatively brief time interval, based on historical actions by users satisfying the targeting criteria, the online system 140 determines a probability of the number of specific actions occurring. For example, if the received information specifies 5,000 guaranteed installations of an unpopular application (e.g., an application on how to groom a honey badger) within a short amount of time (e.g., one day), the online system 140 determines 320 a low likelihood of achieving the guarantee because of the high number of installations the advertiser is requesting, the unpopularity of the content, and the short timeframe in which to achieve the guarantee.

In some embodiments, the online system 140 also determines 330 a premium that is optionally used to calculate a price for a guaranteed advertisement. The premium accounts for revenue potentially lost by the online system 140 by presenting an advertisement associated with a guaranteed number of actions rather than conventional advertisements. In one embodiment, the premium is based on a margin of error in determinations of the likelihood of the number of guaranteed actions occurring. For example, the premium accounts for the online system 140 potentially underestimating the number of presentations of an advertisement for achieving a guaranteed number of actions and adjusts the price of the advertisement to offset revenue potentially lost by a decrease in presentation of conventional advertisements by presenting an advertisement greater than a predicted number of times to achieve a guaranteed number of actions associated with presentation of the advertisement. In one embodiment, the premium is proportional to the risk of lost revenue, so a higher risk of lost revenue causes an increased premium.

A price for a guaranteed advertisement is calculated 340 based on the target bid amount for the guaranteed advertisement and the predicted likelihood of the number of actions identified by the received information occurring if the guaranteed advertisement is presented to online system users. In some embodiments, the price is also adjusted by the premium. For example, the price for an advertisement associated with a guaranteed number of impressions is very low if the guaranteed number impressions is less than a threshold amount (e.g., 50) and the display times and timeframe for achieving the guarantee satisfy at threshold condition (e.g., 24 hours a day for one month) because there is at least a threshold likelihood of the guaranteed number of impressions occurring and the small number of guaranteed impressions result in a small margin of error. Alternatively, the price for an advertisement associated with a guaranteed number of actions may be very high if greater than a threshold number of actions are identified (e.g., 10,000 application installations) and the display times and timeframe in which to achieve the guarantee are less than a threshold condition (e.g., one hour a day for two days) because there is less than a threshold likelihood of achieving the guarantee and large number of guaranteed actions results in a large margin of error for the prediction of the likelihood of the number of impressions occurring.

The price is a flat fee paid received by the online system 140 from an advertiser in exchange for presenting an advertisement so the guaranteed number of actions or impressions occur. In various embodiments, the price is charged as a lump sum or is allocated on a per-impression or per-action basis. For example, if the online system 140 calculates a price of $1,000 for 500 guaranteed video plays, rather than charging the advertiser $1,000 once, the online system 140 charges the advertiser $2 each time a video is played. The calculated price may be presented to an advertiser when a request to present a guaranteed advertisement is received. Alternatively, the calculated price is presented to the advertiser when the online system 140 receives a bid amount for an advertisement.

### Delivery and Payment Methods for Guaranteed Advertisements

The online system 140 delivers a guaranteed advertisement to users and receives payment from an advertiser when the advertiser agrees to the price for the guaranteed advertisement. Different methods of delivering advertisements may be used to increase the likelihood of the number of guaranteed actions or impressions occurring. For guaranteed advertisements where a number of actions are guaranteed the online system 140 may determine whether to deliver an advertisement to a user based on the guaranteed advertisement's targeting criteria and a predicted likelihood that a user performs the guaranteed action if presented with the guaranteed advertisement; the online system 140 may limit presentation of an advertisement to users having at least a threshold likelihood of performing the guaranteed action.

If a guaranteed advertisement is to be presented in a scrollable advertisement unit that presents one or more advertisements at a time, the guaranteed advertisement may be placed in a position within the scrollable advertisement unit most conducive to achieving the guarantee. For example, for a guaranteed advertisement having a guaranteed number of impressions, the guaranteed advertisement is placed in a position in the scrollable advertisement unit where it is visible without user interaction. As another example, for a guaranteed action associated with a guaranteed number of actions, the guaranteed advertisement is placed in a position within the scrollable advertisement unit where it is not presented unless a user interacts with the scrollable advertisement unit to exploit an increase in probability of a user accessing an advertisement that is proportional to the amount of interaction with the scrollable advertisement unit to view the advertisement. As users willing to scroll through advertisements to view additional advertisements are more likely to be interested in the advertisements, such a placement increases the likelihood of a user accessing the advertisement to increase the likelihood of achieving the guaranteed action.

Different methods for the online system 140 to receive payment from an advertiser for a guaranteed advertisement may be used based on the delivery method of the guaranteed advertisement and vice versa. In one embodiment, the online system 140 charges an advertiser for a guaranteed advertisement and displays the guaranteed advertisement to users until the guaranteed number of impressions or actions is achieved. For example, the online system 140 charges an advertiser for 1,000 guaranteed impressions or actions of a guaranteed advertisement and presents the guaranteed advertisement to online system users satisfying the guaranteed advertisement's targeting criteria until 1,000 impressions or actions occur. In another embodiment, the online system 140 does not charge an advertiser until the guaranteed number of impressions or actions of a guaranteed advertisement occurs. For example, the online system 140 charges an advertiser for a guaranteed advertisement after the online system 140 receives 1,000 interactions with the advertisement in a specified period of time. In yet another embodiment, the online system 140 charges an advertiser when each impression or action associated with a guaranteed advertisement occurs. For example, if an advertiser agrees to pay $1,000 for 500 accesses, rather than charging the advertiser $1,000 upfront or after the 500 accesses have occurred, the online system 140 amortizes the cost across the occurrence of each access.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at an online system, information about an advertisement from an advertiser, the information including a guarantee of a number of one or more actions associated with presenting the advertisement to one or more users of the online system occurring;
determining a target bid amount associated with the advertisement, the target bid amount indicating an amount of compensation to the online system to select the advertisement from one or more advertisements for presentation to the one or more users of the online system;
determining a likelihood of at least the number of the one or more actions associated with presenting the advertisement to one or more users of the online system occurring if the advertisement is presented to the one or more users of the online system; and
determining a price for the guarantee of one or more actions associated with presenting the advertisement to one or more users of the online system based at least in part on the target bid amount associated with the advertisement and the determined likelihood.

2. The method of claim 1, wherein the price for the guarantee of one or more actions associated with presenting the advertisement is further based on a premium specifying a measure of risk to the online system associated with presenting the advertisement rather than an additional advertisement.

3. The method of claim 2, wherein the risk to the online system associated with presenting the advertisement is based at least in part on one or more selected from a group consisting of: the predicted bid amount, the determined likelihood, and any combination thereof.

4. The method of claim 1, wherein the information about the advertisement is selected from a group consisting of: advertisement content for the advertisement, targeting criteria for the advertisement, display times for the advertisement, and any combination thereof.

5. The method of claim 1, wherein the guarantee of one or more actions associated with presenting the advertisement to one or more users of the online system specifies a number of impressions of the advertisement.

6. The method of claim 1, wherein the guarantee of one or more actions associated with presenting the advertisement to one or more users of the online system specifies a number of interactions with the advertisement by users of the online system.

7. The method of claim 6, wherein the number of interactions with the advertisement by users of the online system is selected from a group consisting of: a number of times the advertisement is accessed, a number of times a preference for the advertisement is indicated, a number of installations of an application associated with the advertisement, a number of times an application associated with the advertisement is accessed, a number of purchases of a product associated with the advertisement, a number of purchases of a service associated with the advertisement, a number of views of data associated with the advertisement, a number of conversions associated with the advertisement, a number of subscriptions associated with the advertisement, a number of interactions with the advertisement, and any combination thereof.

8. The method of claim 1, wherein the likelihood of at least a threshold number of actions in the guarantee associated with presenting the advertisement occurring if the advertisement is presented to the one or more users of the online system is based on one or more selected from a group consisting of: advertisement content for the advertisement, targeting criteria for the advertisement, display times for the advertisement, and any combination thereof.

9. The method of claim 1, wherein the determined price for the advertisement is a bulk price associated with presenting the advertisement to the one or more users of the online system.

10. The method of claim 1, wherein determining a price for the guarantee of one or more actions associated with presenting the advertisement to one or more users of the online system comprises:
dividing the price by a number of actions associated with presenting the advertisement to one or more users of the online system.

11. The method of claim 1, wherein the information about the advertisement includes one or more characteristics of users of the online system eligible to be presented with the advertisement.

12. A method comprising:
receiving, at an online system, information about an advertisement including a guarantee of a threshold number of one or more actions associated with presenting the advertisement to one or more users of the online system;
ranking a plurality of advertisements based at least in part on bid amounts associated with the advertisements;
determining a target bid amount associated with the advertisement based at least in part on the ranking, the target bid amount indicating an amount of compensation to the online system to select the advertisement for presentation to the one or more users of the online system;
determining a likelihood of at least the threshold number of actions in the guarantee associated with presenting the advertisement occurring if the advertisement is presented to the one or more users of the online system; and
determining a price for the guarantee of one or more actions associated with presenting the advertisement to one or more users of the online system based at least in part on the target bid amount associated with the advertisement and the determined likelihood.

13. The method of claim 12, wherein the price for the guarantee of one or more actions associated with presenting the advertisement is further based on a premium specifying a measure of risk to the online system associated with presenting the advertisement rather than an additional advertisement.

14. The method of claim 13, wherein the risk to the online system associated with presenting the advertisement is based at least in part on one or more selected from a group consisting of: the predicted bid amount, the determined likelihood, and any combination thereof.

15. The method of claim 12, wherein the information about the advertisement is selected from a group consisting of: advertisement content for the advertisement, targeting criteria for the advertisement, display times for the advertisement, and any combination thereof.

16. The method of claim 12, wherein the guarantee of one or more actions associated with presenting the advertisement to one or more users of the online system specifies a number of impressions of the advertisement.

17. The method of claim 12, wherein the guarantee of one or more actions associated with presenting the advertisement to one or more users of the online system specifies a number of interactions with the advertisement by users of the online system.

18. The method of claim 17, wherein the number of interactions with the advertisement by users of the online system is selected from a group consisting of: a number of times the advertisement is accessed, a number of times a preference for the advertisement is indicated, a number of installations of an application associated with the advertisement, a number of times an application associated with the advertisement is accessed, a number of purchases of a product associated with the advertisement, a number of purchases of a service associated with the advertisement, a number of views of data associated with the advertisement, a number of conversions associated with the advertisement, a number of subscriptions associated with the advertisement, a number of interactions with the advertisement, and any combination thereof.

19. The method of claim 12, wherein the likelihood of at least the threshold number of actions in the guarantee associated with presenting the advertisement occurring if the advertisement is presented to the one or more users of the online system is based on one or more selected from a group consisting of: advertisement content for the advertisement, targeting criteria for the advertisement, display times for the advertisement, and any combination thereof.

20. The method of claim 12, wherein the computed price for the advertisement is a bulk price associated with presenting the advertisement to the one or more users of the online system.
